(19) United States
(12) Patent Application Publication
(10) Pub. No.: US 2009/0116342 A1
(43) Pub. Date: May 7, 2009

(54) Movable clock

(76) Inventor: Chien-Min Chen, Taipei (TW)

Correspondence Address: CHEN, CHIEN-MIN, P.O.Box 166-13, Taipei, 115, TW

(21) Appl. No.: 11/979,658

(22) Filed: Nov. 7, 2007

(51) Int. Cl. G04B 47/00

(52) U.S. Cl. 368/10

(57) ABSTRACT

A movable clock includes a control system (10) having a printed circuit board (PCB, 11), a clock (12), and batteries (13); a wheeled vehicle (20) having a first geared motor (21) to drive a set of universal rollers (23); a housing (31) having a base (31) and a dome (32) installed with light emission diodes (16a); said control system (10) hidden inside the dome, said wheeled vehicle (20) partly mounted within the base (31); and an on-off switch (40) exposed outside the housing (30) electrically connected to the PCB (11) turns off a horn (15), the first geared motor (21), and light emission diodes (LEDs, 16a). Hour/minute/second hands on a dial of the clock pointed to a preset time notation, a signal transmitted to the PCB (11) activates the horn (15), the first geared motor (21) to move the base (31), light up the LEds (16a) and wake up user.

### FIELD OF THE INVENTION

The present invention is related to a movable clock, which is controlled by a preset time notation on a dial of the clock to trigger sound, light, and movements of the movable clock to wake up user.

### DESCRIPTION OF PRIOR ARTS

Usually, an alarm clock is placed beside bed, or anywhere can be reached by user's hand. When tick of the clock is approaching to a preset time notation of a dial, of which hour hand, minute hand, and second hand is pointed to a demanded time, a horn is chimed to wake up the user. However, user may hide the alarm clock under his pillow, further he makes the alarming clock a dumb thing to turn off the urging horn for a doze with dizziness. Therefore, a movable clock, if any, can alarm user, who could only jump out of bed and manages to catch the clock and wake up in time.

Accordingly, the present invention is to provide a movable clock for arousing users at a demanded time; furthermore, the movable clock is smart to radiate sound and light, accompanied by, if detected, a left turn or a right turn to distance users; who must find their ways to compromise with the naughty movable clock.

### SUMMARY OF THE INVENTION

The present invention is to provide a movable clock comprising: a control system (10) includes a printed circuit board (PCB, 11), a clock (12) electrically connected to the PCB (11), a horn (15) electrically connected to the PCB (11);

A wheeled vehicle (20) includes a first geared motor (21) electrically connected to the PCB (11), the first geared motor (21) drives a set of universal rollers (23) support for the wheel vehicle (20) to drive straight ahead, turn right, or turn left by a set of gear reducer (22);

A housing (30) includes a base (31), and a dome (32); the control system (10) disposed above the base (31) and hidden inside the dome (30), while the wheeled vehicle (20) is rotated below the base (31) for ease of transportation; an upper half portion of the dome (30) is inlaid with a transparent lens (321), by which a dial of the clock (12) is clearly seen therethrough, a bore (311) centrally formed through a front portion of the base (31) accommodates the set of universal rollers (23) mounted within the base, and, at least, one roller (33) is centrally disposed below a rear portion of the base (31); and

An on-off switch (40) disposed to a front side of the housing (30) is electrically connected to the PCB (11) to turn off the horn, further cut off power source of the wheeled vehicle (20).

Light emission diodes (LEDs, 16) disposed inside the dome (32) are electrically connected to the PCB (11), whether the LEDs are electrified to light or not are determined by the on-off switch (40).

The on-off switch (40) consists of a supporting frame (40a) disposed to a front side of the housing (30) is hidden inside the dome (31), and a switch pole (40b) coupled to the supporting frame (40a) is exposed outside the housing (32), the supporting frame (40a) is also electrically connected to the PCB (11).

A passive infrared sensor (PIR) based motion detector based motion detector (14) electrically connected to the PCB (11) is coupled to a bottom of the switch pole (40b) for monitoring road condition, a second geared motor (51) mounted on the base (31) starts rotating a rotating base (50) by a set of gear reducer (52), the second geared motor (51) is electrically connected to and activated by the PCB (11), which is in response to signals transmitted by the passive infrared sensor based motion detector (14) to activate the second geared motor (51).

An alternate current (AC) outlet (131) disposed on the dome (32), the outlet is electrically connected to a set of rechargeable batteries.

An alternate embodiment of the present invention discloses a movable clock comprising: a control system (10) includes a PCB (11), a clock (12) electrically connected to the PCB (11), the PCB (11) and the clock (12) are powered by a set of batteries (13), a horn (15) electrically connected to the PCB (11);

A wheeled vehicle (20) includes a first geared motor (21) electrically connected to the PCB (11), the first geared motor (21) drives a set of universal roller (23) by a set of gear reducer (22);

A housing (30) includes a base (31) accommodates the control system (10) mounted above and the wheeled vehicle hung below, a transparent dome (32) covers up the base (31); a front portion of the base has a bore (311) accommodates the set of universal rollers (23) mounted within, at least, one roller (33) disposed below a rear portion of the base (31); and

An on-off switch (40) disposed on an upper portion of the clock (12) is exposed outside a bore in the middle of a front side of the dome (32), and the on-off switch (40) is electrically connected to the PCB (11) to turn off the horn (15) and cut off power to the wheeled vehicle (20).

Light emission diodes (LEDs, 16a) disposed inside the dome (32) are electrically connected to the PCB (11), the on-off switch (40) cuts off power to dim LEDs (16a).

A passive infrared sensor based motion detector (14) disposed below a front portion of the base (31) is electrically connected to the PCB (11), the wheeled vehicle (20) disposed within a rotating base (50), a second geared motor (51) mounted on the base (31) starts rotating the rotating base (50) by a set of gear reducer (52), the second geared motor (51) is electrically connected to the PCB (11), which is in response to signals transmitted by the passive infrared sensor based motion detector (14) to activate the second geared motor (51).

An alternate current (AC) outlet (131) disposed on the dome (32); the outlet is electrically connected to a set of rechargeable batteries.

### ADVANTAGES OF EMBODIMENTS OF THE INVENTION

Since tick of the clock (12) eventually enters a desired time increment by one minute increment or even one second increment, when an hour hand, a minute hand, and a second hand on a dial of the clock is pointed to a preset time notation, the set of universal rollers starts rolling on at a speed to move about a place where the movable clock (1) is originally placed at a distance, at least, out of a stretching out hand of user; at the same time, the chime is activated as car horn (15) tones are heard by user, and LEDs (16a, 16b) are lit. Since the movable clock (1) is continuous to move about a place out of reach for the user, who jumps out of bed and searches out the movable clock by hand immediately. Otherwise the set of universal rollers (23), the horn (15), and LEDs (16a, 16b) will not stop moving, chiming, and lighting respectively, unless wake-up user make a compromise with the movable clock.

The passive infrared sensor based motion detector (14) detects road condition when the movable clock is activated to move about, where up and down on the temporal way can be detected, and the movable clock is to change a direction at a right angle, which is selectively to turn right or left see whether a motion of the user or any barrier presented before the movable clock higher than a leveled surface over a preset height, after changing direction, the movable clock continues to move about.

The on and off switch is composed of a supporting frame (40a), and a switch pole (40b) wherein the switch pole (40b) is exposed outside the dome (32), and the switch pole (40b) can be shaped as a beloved pet form and structure, such as a turtle's head extended out of a boulle likely made of turtle shell. As a result, the on and off switch (40) is incorporated to the fashioned style movable clock.

### BRIEF DESCRIPTION OF DRAWINGS

FIG. 1: shows an exploded view of the first embodiment of the present invention;

FIG. 2: shows a sectional view of the movable clock;

FIG. 3: shows a diagrammatic view of the movable clock activated in a series of arrow heads indicated electrically connected elements are activated in order of FIG. 1;

FIG. 4: shows a diagrammatic view of electric wiring diagram of FIG. 1;

FIG. 5: shows an exploded view of the second embodiment of the present invention;

FIG. 6: shows a sectional view of FIG. 5;

FIG. 7: shows a diagrammatic view of the movable clock activated in a series of arrow heads indicated electrically connected elements are activated in order of FIG. 5;

FIG. 8: shows an exploded view of the third embodiment of the present invention;

FIG. 9: shows a sectional view of FIG. 8; and

FIGS. 10˜11: show schematic views of rollers of the invention in use.

### DETAILED DESCRIPTION OF THE PREFERRED EMBODIMENTS OF THE PRESENT INVENTION

The description is described in detail according to the appended drawings hereinafter.

### First Embodiment

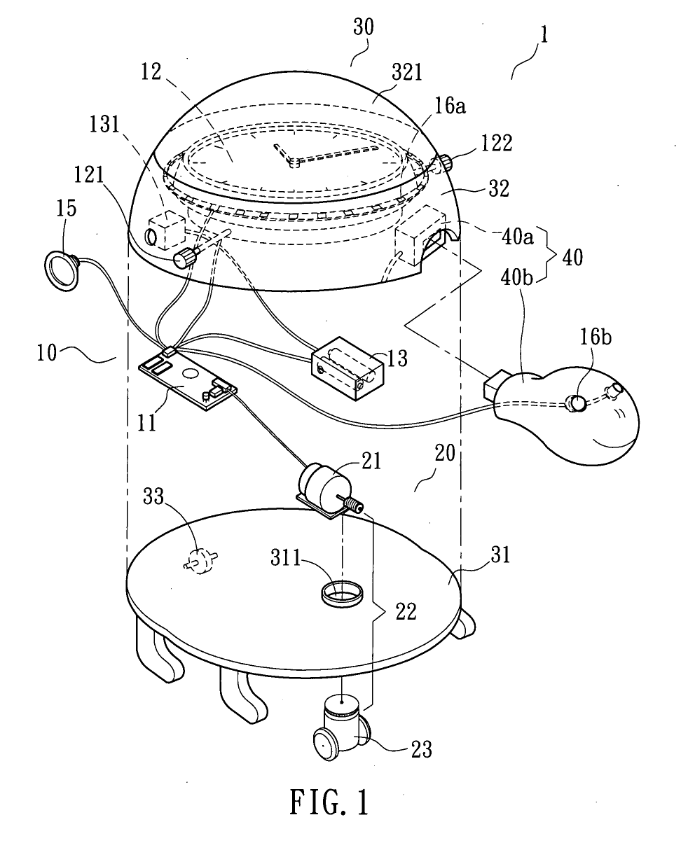

As shown in FIGS. 1-4, a movable clock (1) is composed of a control system (10), a wheeled vehicle (20), a housing (30) and an on-off switch (40).

Said control system (10) includes a printed circuit board (PCB, 11), a clock (12) is electrically connected to the PCB (11), a set of batteries (13) power the PCB and the clock. And a horn (15) is electrically connected to the PCB (11).

Said wheeled vehicle (20) includes a first geared motor (21), which drives a set of universal rollers (23) by a set of gear reducer (22).

The set of gear reducer (22) includes a worm at a reduced speed operated by the first geared motor (21), and gears of the set of universal rollers (23). Or a set of umbrella gears (not shown) can be used instead of the set of gear reducer (22).

Said housing (30) includes a base (31) accommodates the control system (10) mounted thereon and hidden inside a dome (32); in addition, the wheeled vehicle (20) is partly mounted within a bore (311) formed through the base (31), and the wheeled vehicle (20) is incorporated to the base (31) and, at least, two wheels of the wheeled vehicle (20) are hung and rolled below the base (31). Whereby, the wheeled vehicle (20) is substantially disposed below the base (31) but not covered up by the dome (32).

An upper half portion of the dome (32) is inlaid with a transparent lens (321), by which a twelve hour or twenty four hour dial of the clock (12) mainly with hour hand, minute hand and/or digital notations is seen through the transparent lens to show tick of clock on changing digital notations or movements of hour/minute/second hands. The bore (311) is centrally formed through a front portion of the base (31). At least, a roller is centrally disposed below a rear portion of the base (31). Two adjustable knobs (121, 122) are disposed on the dome (32), where the first knob (121) is used to adjust a time period upon which the movable clock is to be activated; the second knob (122) is used to adjust hour/minute/second hands or digital time notations for showing a correct time for turning on well-timed clock chime, light, and movement.

Said on-off witch (40) is disposed to a front side of the housing (30), it is composed of a supporting frame (40a) disposed on the base (31) to a front end but hidden inside the dome (32), and a switch pole (40b) coupled to the supporting frame (40a) is exposed outside the dome (32). The supporting frame (40a) is electrically connected to the PCB (11) to turn off the horn (15) and cut off power source of the wheeled vehicle (20).

In addition, light emission diodes (LEDs, 16a) are not only disposed inside the dome (32) but also disposed inside the on-off switch (40). LEDs (16a) are electrically connected to the PCB (11). A power source of the LEDs (16a) can be cut off by the on-off switch (40). Furthermore, LEDs (16b) disposed inside the switch pole (40b) are electrically connected to the PCB (11) can be controlled by the on-off switch (40).

Besides, an alternate current (AC) outlet disposed on the dome (32) is electrically connected to a set of rechargeable batteries (13). Or, to facilitate a movable clock moving about users wildly, replaceable conventional high duty batteries can be used instead.

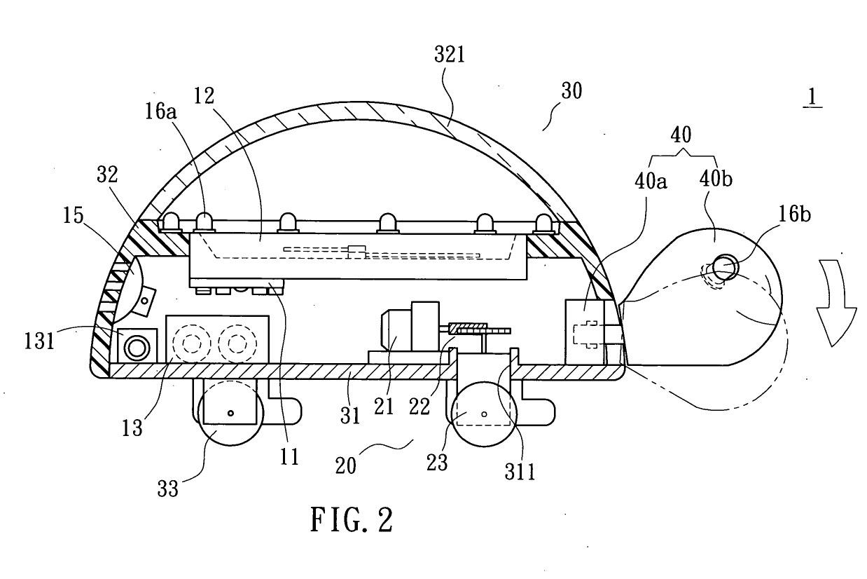

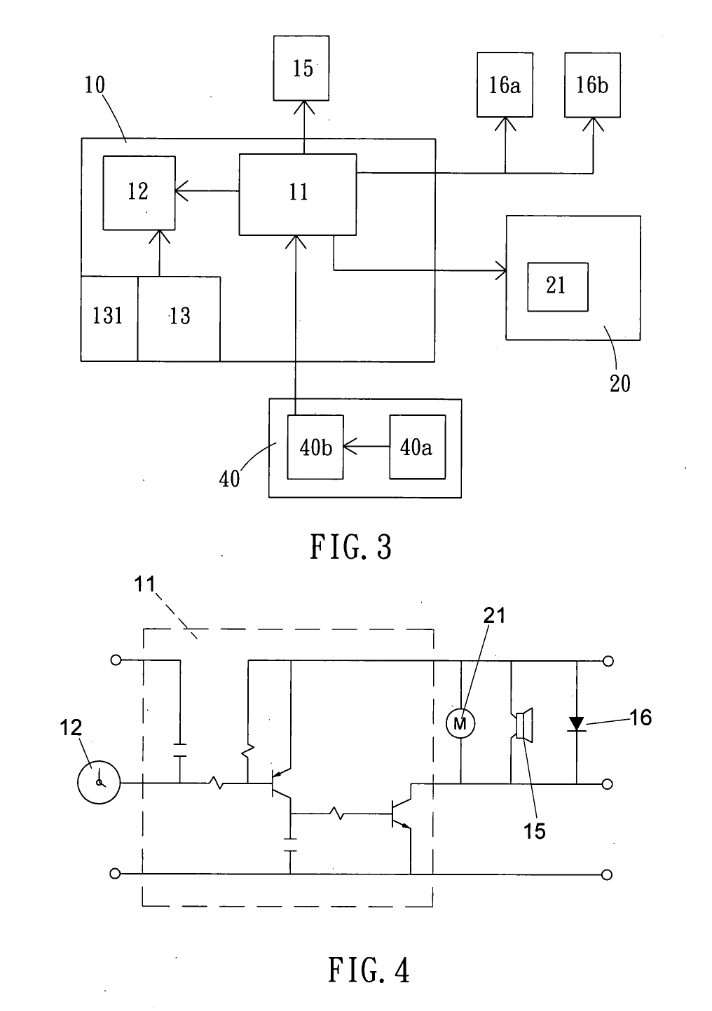

As shown in FIGS. 3-4, as hour/minute/second hands or digital time notations on a dial of the clock automatically clicks to a preset time notation, a small power current as a signal of the control system is transmitted to the PCB (11), where integrated circuit (IC) is electrified to start running solution to the first geared motor (21) and rolling the set of universal rollers (23). Clock chime is played by the horn (15), and LEDs (16a, 16b) light up. But when user presses down the switch pole (40b) (as indicated by arrow in FIG. 2), which transmits a signal to the PCB (11) to cut off power supply to the first geared motor (21), the horn (15), and the LEDs (16a). Thereby the movable clock (1) stops moving.

### Second Embodiment

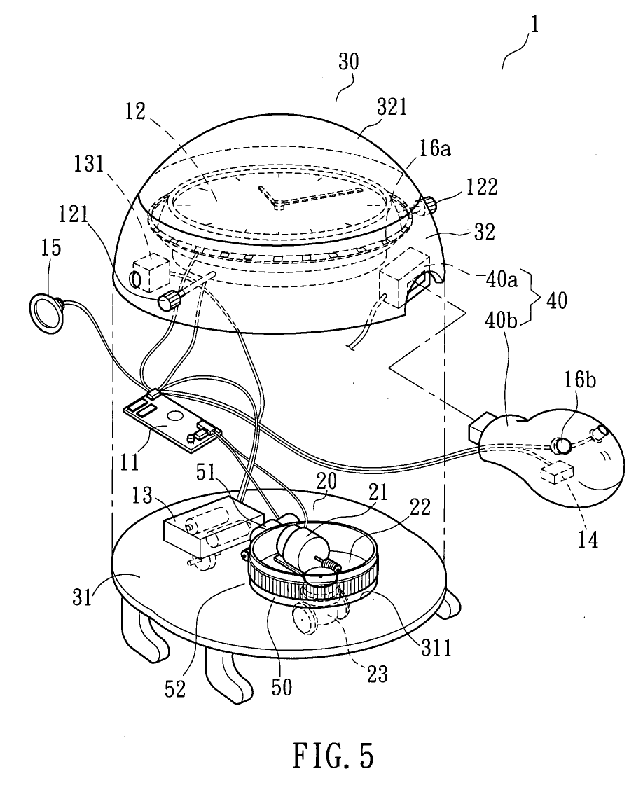

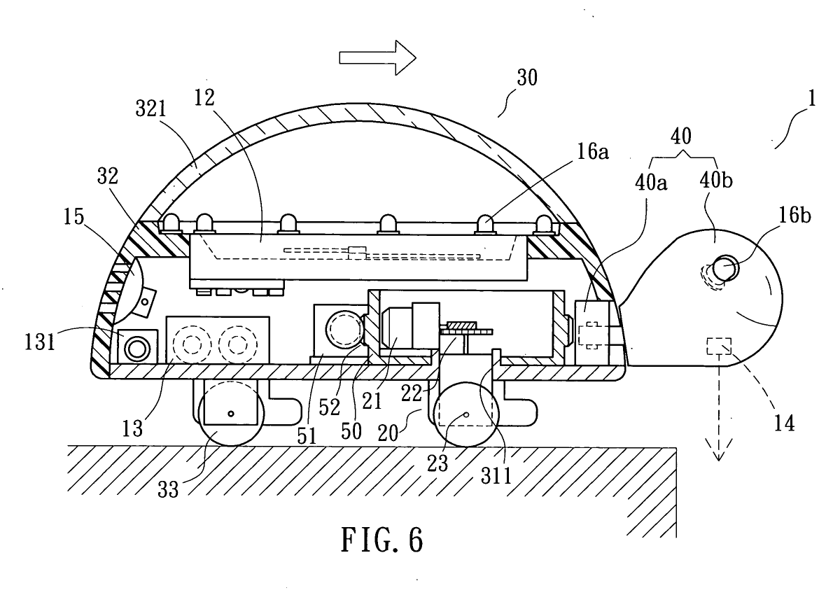

As shown in FIGS. 5-7, a second embodiment of the present invention is illustrated. The second embodiment is different from the first embodiment by a passive infrared sensor based motion detector (14) electrically connected to the PCB (11) is coupled to a bottom of the switch pole (40b) facing frontward to monitor road condition. Said wheeled vehicle (20) is mounted within a rotating base (50). A second geared motor (51) mounted on the base (31) starts rotating the rotating base (50) by a set of gear reducer (52). The second geared motor (51) is electrically connected to the PCB (31), when the passive infrared sensor based motion detector (14) transmits signals to the PCB (31), the rotating base (50) is activated.

Said gear reducer (52) are composed of a worm at a reduced speed operated by the second geared motor (51), and a gear rim of the rotating base (50).

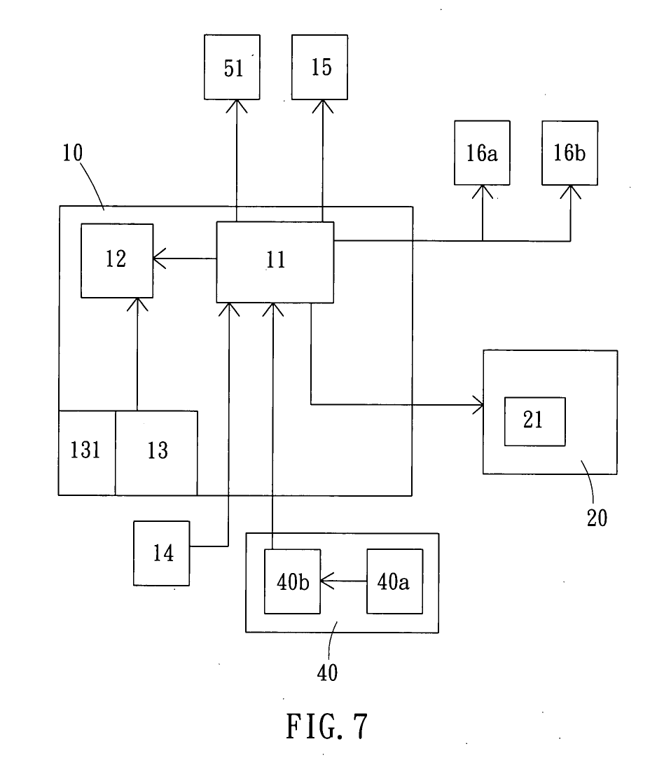

As shown in FIG. 7, the passive infrared sensor based motion detector (14) is mainly included a passive infrared sensor (PIR), which is designed to sense objects motion at a distance in front of the movable clock (1), if the height of objects motion compared to a level surface of ground is in excess of a preset range, the second geared motor (51) is activated to start rotating the rotating base (50) in an alternate direction at a right angle, thereby the movable clock (1) stops to turn right or left in response to whether the object motion is interrupted with the infrared detection signal. Thus, the movable clock (1) is avoided from falling into pits or colliding with objects motion on the way. But, when turning right or left, a time limit control relay is necessary to coordinate the second geared motor (51) stops turning for a time period, or two limit switches (not shown) in contact with the rotating base (50) in an alternative manner can be added to the base (31) instead of the time limit control relay.

### Third Embodiment

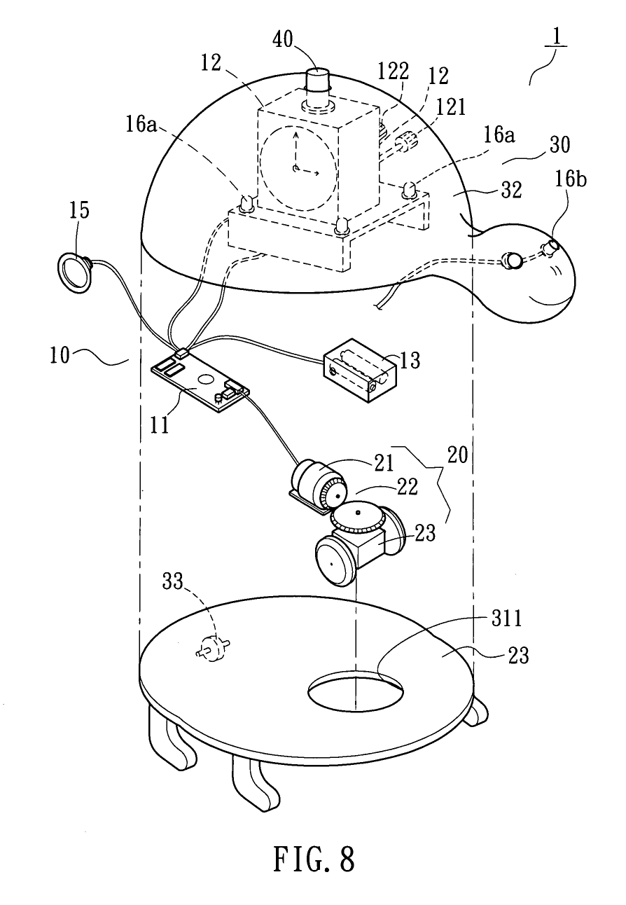

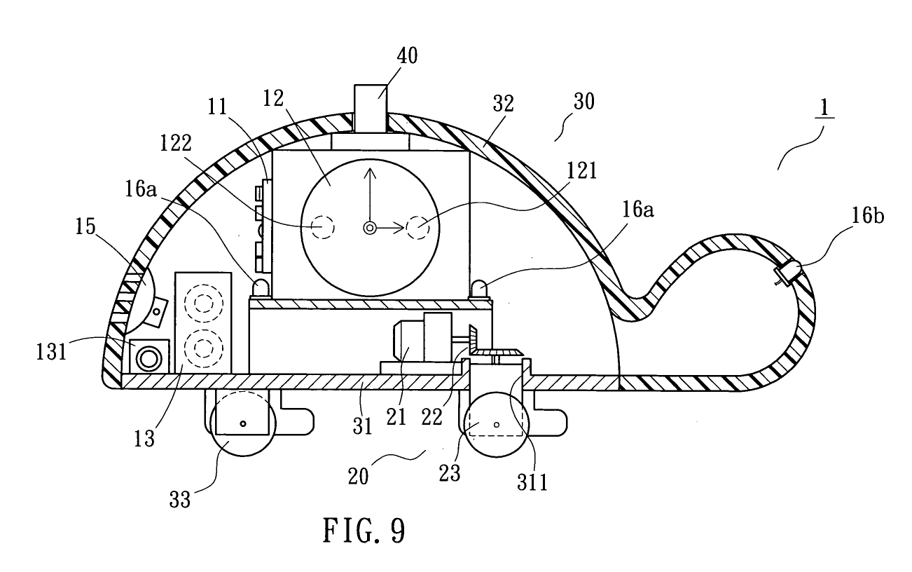

As shown in FIGS. 8-9, the third embodiment is different from the first embodiment by the dome (32). The dome (32) is a transparent body, a dial of clock (12) is facing upward, both adjust knobs (121, 122) are disposed to a left, a right side of the dome (32) respectively. An on-off switch (40) is disposed above the clock (12) and fit through a bore formed through an apex of the dome (32). Normally, the on-off switch (40) is partly exposed outside the apex of the dome (32). The on-off switch is electrically connected to the PCB (11) to turn off the horn and cut off power source of the wheeled vehicle (20) and LEDs (16a, 16b).

When user presses down the on-off switch (40), as arrow heads indicated in FIG. 7, the PCB (11) is activated to cut off power source of said first geared motor (21), horn (15), and LEDs (16a, 16b). The movable clock (1) stops moving around.

### Fourth Embodiment

As shown in FIGS. 9˜11, the movable clock of the third embodiment are illustrated. In which, a passive infrared sensor based motion detector (14) is disposed below a switch pole (41b), in front of and in line with a set of universal rollers (23) centrally disposed below a front portion of the base (31), furthermore, the set of universal rollers (23) incorporated to the wheeled vehicle (20) is mounted within a rotating base (50). In addition, a second geared motor (51) mounted on the base (31) starts rotating the rotating base (50) by a set of gear reducer (52). The second geared motor (51) is electrically connected to the PCB (11), as the passive infrared sensor based motion detector (14) transmits signals to the PCB (11); the second geared motor (51) is activated.

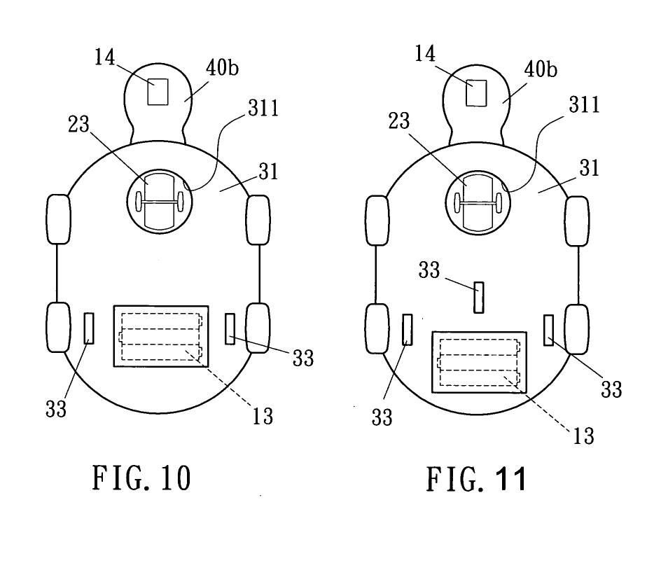

Finally, at least, one roller (33) is centrally disposed below a rear portion of the base (31), basically the only one roller is arranged in line with a middle line of the set of universal rollers (23), but, as shown in FIGS. 10-11, rollers (33) can be added below the rear portion of the base (31). As shown in FIG. 10, two rollers (33) are symmetrically disposed at a left, a right side below the rear portion of the base (31). As shown in FIG. 11, three rollers (33) symmetrically disposed below the rear portion of the base (3) in an isosceles triangular shape. Thus, the movable clock (1) moves around stably.

1. A movable clock comprising: a control system (10) includes a printed circuit board (PCB, 11), a clock (12) electrically connected to the PCB (11), a horn (15) electrically connected to the PCB (11);
a wheeled vehicle (20) includes a first geared motor (21) electrically connected to the PCB (11), the first geared motor (21) drives a set of universal rollers (23) support for the wheel vehicle (20) to drive straight ahead, turn right, or turn left by a set of gear reducer (22);
a housing (30) includes a base (31), and a dome (32); the control system (10) disposed above the base (31) is hidden inside the dome (30), while the wheeled vehicle (20) is rotated below the base (31) for ease of transportation; an upper half portion of the dome (30) is inlaid with a transparent lens (321), by which a dial of the clock (12) is clearly seen therethrough, a bore (311) centrally formed through a front portion of the base (31) accommodates the set of universal rollers (23) mounted within the base, and, at least, one roller (33) is centrally disposed below a rear portion of the base (31); and
an on-off switch (40) disposed to a front side of the housing (30) is electrically connected to the PCB (11) to turn off the horn, further cut off power source of the wheeled vehicle (20).

2. The movable clock of claim 1 wherein light emission diodes (LEDs) (16) disposed inside the dome (32) are electrically connected to the PCB (11), whether the LEDs are electrified to light or not are determined by the on-off switch (40).

3. The movable clock of claim 1 wherein the on-off switch (40) consists of a supporting frame (40a) disposed to a front side of the housing (30) is hidden inside the dome (31), and a switch pole (40b) coupled to the supporting frame (40a) is exposed outside the housing (32), the supporting frame (40a) is also electrically connected to the PCB (11).

4. The movable clock of claim 3 wherein a passive infrared sensor (PIR) based motion detector based motion detector (14) electrically connected to the PCB (11) is coupled to a bottom of the switch pole (40b) for monitoring road condition, a second geared motor (51) mounted on the base (31) starts rotating a rotating base (50) by a set of gear reducer (52), the second geared motor (51) is electrically connected to and activated by the PCB (11), which is in response to signals transmitted by the passive infrared sensor based motion detector (14) to activate the second geared motor (51).

5. The movable clock of claim 3 wherein an alternate current (AC) outlet (131) disposed on the dome (32), the outlet is electrically connected to a set of rechargeable batteries.

6. A movable clock comprising:
a control system (10) includes a PCB (11), a clock (12) electrically connected to the PCB (11), the PCB (11) and the clock (12) are powered by a set of batteries (13), a horn (15) electrically connected to the PCB (11);
a wheeled vehicle (20) includes a first geared motor (21) electrically connected to the PCB (11), the first geared motor (21) drives a set of universal roller (23) by a set of gear reducer (22);
a housing (30) includes a base (31) accommodates the control system (10) mounted above and the wheeled vehicle hung below, a transparent dome (32) covers up the base (31); a front portion of the base has a bore (311) accommodates the set of universal rollers (23) mounted within, at least, one roller (33) disposed below a rear portion of the base (31); and
an on-off switch (40) disposed on an upper portion of the clock (12) is exposed outside a bore in the middle of a front side of the dome (32), and the on-off switch (40) is electrically connected to the PCB (11) to turn off the horn (15) and cut off power to the wheeled vehicle (20).

7. The movable clock of claim 6 wherein light emission diodes (LEDs), (16a) disposed inside the dome (32) are electrically connected to the PCB (11), the on-off switch (40) cuts off power to dim LEDs (16a).

8. The movable clock of claim 6 wherein a passive infrared sensor based motion detector (14) disposed below a front portion of the base (31) is electrically connected to the PCB (11), the wheeled vehicle (20) disposed within a rotating base (50), a second geared motor (51) mounted on the base (31) starts rotating the rotating base (50) by a set of gear reducer (52), the second geared motor (51) is electrically connected to the PCB (11), which is in response to signals transmitted by the passive infrared sensor based motion detector (14) to activate the second geared motor (51).

9. The movable clock of claim 6 wherein an alternate current (AC) outlet (131) disposed on the dome (32); the outlet is electrically connected to a set of rechargeable batteries
